(19) United States
(12) Patent Application Publication
(10) Pub. No.: US 2004/0022714 A1
(43) Pub. Date: Feb. 5, 2004

(54) Method and device for producing nickel sulphamate

(76) Inventors: Graalf Remmers, Garbsen (DE); Horst Lieker, Hannover (DE)

Correspondence Address: Joseph F Posillico, Synnestvedt & Lechner, 2600 Aramark Tower, 1101 Market Street, Philadelphia, PA, 19107-2950, US

(21) Appl. No.: 10/398,597

(22) PCT Filed: Oct. 5, 2001
(86) PCT No.: PCT/EP01/11531

(30) Foreign Application Priority Data
Oct. 5, 2000 (DE) 10049327.0

(51) Int. Cl. C01B 21/093; B01F 1/00

(52) U.S. Cl. 423/388; 422/224; 422/225

(57) ABSTRACT

The method allows for nickel sulphamate to be produced by means of reacting elementary nickel with sulphamic acid. Therein, the nickel is disintegrated by strong stirring, mixing, or dispersing of the nickel-acid mixture by means of a stirring, mixing, or dispersing tool, introducing high energy density into the reaction mixture. Herein, the nickel is oxidized by reduction of the acid protons of the sulphamic acid without adding special oxidization means. The nickel sulphamate contained in an aqueous solution is especially suitable for electroplating technology since it is for the most part free of foreign ions and amorphous nickel sedimentations.

The invention relates to a method for producing nickel sulphamate, in particular for producing a aqueous nickel sulphamate solution for electroplating technology by reacting elementary nickel with sulphamic acid as well as a device for performing this method.

Nickel sulphamate is used in electroplating technology for formulating nickel sulphamate electrolytes. These are known as bathes from which highly pure nickel layers can be sedimentated which are particularly low in internal stress, and which have high ductility and breaking extension value. In order to completely utilize the advantages inherent to the sulphamate system, using additive-free bathes is preferred.

Due to the advantageous physical and mechanical properties of the nickel sedimentated from the sulphamate bathes, nickel-sulphamate bathes are widely used on the more demanding field of electroplating technology, in electrical engineering, and in micro electroplating technology.

Nickel sulphamate solutions can be produced in various ways. Transformations of nickel carbonate and hydrogen carbonate, of nickel hydroxide or also of nickel powder with sulphamic acids are known and used today. The use of nickel salts instead of elementary nickel leads to relatively high ratios of foreign ions which can only be reduced under considerable production expenses. Methods based on nickel salts are thus technically sophisticated, cost-intensive and therefore disadvantageous.

Nickel powder only dissolves very slowly and not completely in sulphamic acid if stirred normally. According to the constant series nickel can be oxidized with acids that supply protons, however, this process could not be used until now technically or could only be used with less pure powder qualities.

Impure powder qualities, however, lead in turn to an increased (perturbing) ratio of foreign ions.

In order to achieve sensible transformation speeds for the whole mixture, the nickel has to be provided in the form of powder or fine granulate. The transformation of pure or purest nickel powder with protonic acids, however, is hindered in such a way, even with fine nickel distribution, due to surface passivation that it can technically not be realized without auxiliary materials.

Due to this, separately added oxygen carriers such as hydrogen peroxide or air are used for oxidizing. Since these methods usually utilize surpluses of nickel powder in the reaction concept, in order to achieve an economically sensible transformation time, there is the danger that the pH end-point is exceeded, that the solution “tilts”, and a bath electrolyte is supplied which results in undesired, dark-blackish colored nickel sediments. Moreover, the use of hydrogen peroxide results in introducing perturbing substances such as stannate, picoline etc., accompanying hydrogen peroxide as stabilizers.

Highly pure “Mond nickel powder”, produced in accordance with the Mond method, is particularly difficult to dissolve. However, utilizing this powder would be of particular interest in electroplating technology for its purity and the extremely low content of cobalt.

Ions introduced in the production of the nickel sulphamate, may considerably influence the sedimentation quality of the solution, as already mentioned above. Such ions take part in the electrodeposition processes and influence them. It is known that cationic species may be present in the form of aqueous complexes, which are, generally speaking, not monomeric but lead to hydroxo- or oxo-bridged complex polymers. These “complex nickel” influences the electrolyte double layer and thus the kinetics of the metal sedimentation, and should therefore be avoided as far as possible.

Therefore, it is the invention's object to provide a method for producing nickel sulphamate, in particular in aqueous solution, wherein the presence of perturbing foreign ions and impurities as well as of complex nickel is avoided as far as possible.

Moreover, the method should keep the content of ammonium contained in the nickel sulphamate produced or in the solution below 100 ppm since ammonium contents also have negative effects on the breaking extension value and ductility of the nickel sedimentations.

Additionally, the method is to avoid passing through critical pH ranges, wherein polymeric structures can be formed.

For solving the afore-mentioned problem, the invention provides oxidizing the nickel by reduction of acid protons of the sulphamic acid in a method for producing nickel sulphamate by reacting elementary nickel with sulphamic acid, and to activate this process by heavy stirring, mixing, or dispersing of the nickel-acid mixture with a stirring, mixing, or dispersing tool, creating a high energy density by creation of strong turbulence and/or introduction of high shear force.

The stirring, mixing, or dispersing power, making possible the disintegration process, i.e. activation of nickel, can e.g. be characterized by shear speeds between 20,000 and 100,000 1/s.

In a preferred embodiment, the stirring, mixing, or dispersing tool is formed in such a way that a rotating part achieves a peripheral velocity of 10 to 40 m/s.

The high shear speed of up to 100,000 1/sec, created due to the rotors with high frequencies, as well as the turbulences, created in the tool's head, determine the high density of energy causing effective disintegration of the nickel.

The method as per the invention allows transformation also of highly pure nickel powder such as Mond nickel powder with sulphamic acid under a transformation speed which cannot be achieved with processes using hydrogen peroxide oxidation or air oxidation. The method as per the invention consistently renounces basic nickel precursors, such as carbonate or hydroxide as well as oxidation of nickel with oxygen carriers. Critical pH ranges, complexes, and polymeric nickel structures and black amorphous nickel sedimentations created thereby are avoided.

Preferably, the invention uses stirring with a stream stirrer, which can be provided as sucking jet stirrer. A sucking jet mixer with rotor-stator system has been proven to be particularly appropriate for performing the method as per the invention. In general, the used stirrer should have the following characteristics: mixing tool or generator, respectively, with rotor/stator combinations, wherein the stator may comprise a classic guiding tube as well as one or more toothed rings. Preferably, the stirrer causes sufficient subatmospheric pressure so that this depression can be used for introducing the solid components into the reactor, and/or is also appropriate for introducing air in order to have sufficient amounts of dilution air provided in order to maintain the lower explosion limit, in view of hydrogen generated during reaction.

The stirrer used should be provided in such a way that it is introducing to the stirring stock high shear forces as well as turbulences (in the range of the mixing head). Therein, the stirring blade or stirring element should have a peripheral velocity of not below 10 m/s, wherein the introduction of high shear forces is essential for the success of the method.

Variants of the mixing or dispersing tools are possible. Besides classic rotor/stator combinations, the stators can, e.g., be provided as toothed rings so that, in this case, the medium's output is not only performed axially but (also) radially.

The mechanical energy input and/or an abrasive effect on the nickel surface add decisively to the activation of the nickel powder in order to have the nickel oxidation with acidic protons performed with satisfying speed.

Nickel powder is used preferably, more preferably, highly pure nickel powder such as Mond nickel powder, i.e. nickel powder produced in accordance with the Mond method, is used.

The molar ratio of nickel to acid should be higher than 1, i.e. should be over-stoichiometric with regard to the stoichiometric ratio of 1:2; in a preferred embodiment, a molar ratio of 1.18:2 is presently used for nickel:acid.

The reaction is preferably performed with temperatures below 40° C., i.e. under mild conditions.

In a further embodiment of the invention, the elementary nickel—as described above in the form of Mond nickel powder—is placed in water and the sulphamic acid is added.

The water used for setting the reaction conditions with regard to pH value, stoichiometric ratios and solution concentrations is at least deionized water or super-pure water.

The sulphamic acid can continuously be added in controlling the pH value or can be added by portions, preferably in at least three or more smallest possible steps.

During the addition of the sulphamic acid, the pH value is kept between 2 and 3 for as long as possible before the pH value is increased to a final value of about or more than 4, preferably 4.2. The reaction can, however, also be performed in weaker acid ranges as long as the creation of ammonium ions, aqueous complexes, and polymers is sufficiently suppressed.

The object of the invention is also solved by providing a device for performing the method as per the invention.

The device comprises a stream stirrer or disperser, working with high frequency and provided within a stirring container, a sucking element, preferably a sucking lance, connected with the stirrer or disperser, by means of which the nickel powder and/or the dilution air are introduced into the stirring container of the stirring machine via the stirrer, as well as at least one dosing device for adding the sulphamic acid into the stirring container.

The stream stirrer or disperser comprises a rotor/stator system and is therefore able to add high shear forces to the mixture to be stirred. In general, a sucking jet stirrer or a classic conducting stream stirrer can be used. Preferably, those parts of the stirrer in contact with the product are made of titan. Nickel or substances which do not affect the nickel solution's bath quality by introducing foreign ions, such as ceramics or hard materials, can be used.

The use of the sucking jet stirrer combines the following technical advantages, decisive for the invention:

the high shear force of the stirring device makes an increase of the transformation speed, decisive for the invention, still causing satisfactory transformation times even with pH 3. This considerably limits the hydrolytic creation of ammonium ions and avoids the formation of aqueous complexes;

the air sucked in by the stirrer merely serves as a dilution medium and excludes an exceeding of the lower explosion limit;

the introduction of the toxic nickel powder into the reactor can be performed environmentally friendly and safely by sucking and due to the formation of subatmospheric pressure of the stirrer.

The method as per the method has been compared with known methods in comparative tests and has been proven to be clearly advantageous.

Comparative Tests:

The transformation speeds of Mond nickel powder with sulphamic acid decrease considerably dependent upon the method and in correspondence with the following sequence: as per the invention (using a stream stirrer)—hydrogen peroxidization—air oxidization. The two methods not using a stream stirrer can merely be performed under stricter conditions and with less positive results, whilst the sucking jet or air stream stirrer allows working at temperatures below 40° C. and within pH ranges between 2 and 3, controlled by regulated addition of sulphamic acid, so that the ammonium ion content is kept below 100 ppm due to less hydrolysis caused by acid and temperature and so that creation of nickel complexes is avoided.

In order to show the superiority of the method as per the invention, comparative tests were performed, comparing three different production methods for nickel sulphamate, i.e. 1. using air oxidation, 2. using hydrogen peroxidizazion, and 3. using air or sucking jet streaming.

The test data are given in table 1:

TABLE 1

| | air | hydrogen | air streaming |
|---|---|---|---|
| | oxidation | peroxidization | (present |
| | (prior art) | (prior art) | invention) |
| amounts used: | | | |
| Mond nickel (g) | 6o0 | 600 | 600 |
| (NH₂)SO₃H(g) | 1685 | 1685 | 1685 |
| H₂O(g) | 740 | 740 | 740 |
| molar ratio Ni:acid | 1:1.7 | 1:1.7 | 1:1.7 |
| temperature range (° C.) | 45-50 | 60-65 | 38-40 |
| preheating to react. temp. | X | X | X |
| cooling | X | X | X |
| Dosing of acid | | | |
| a) continuously, pH 2-3 | not | not | X |
| | applying | applying | |
| b) pH < 2.0; 3 steps à 561 g | X | X | not |
| | | | applying |
| reaction time (h) | 76 | 52 | 24 |
| (final point 11% Ni pH 4.2) | | | |
| NH4 content (ppm) | 560 | 680 | 92 |
| complex Ni (mg/100 ml) | 264 | 188 | 5.7 |

The production variants are performed within a glass reaction container, 5-liter-size and cooled by water, worked with 3 liters of reaction mixture, and provided with reflux condenser.

For air oxidation, the reactor was provided with a nozzle ring system and a quick working propeller mixer. The nickel powder was introduced, highly pure water was suspended in the calculated amount, and the reaction acid was added in three portions, each coming up to a third of the whole amount.

Transformation by means of hydrogen peroxidization has been conducted in a similar way as far as the concept is concerned. The nozzle ring system was removed, a dosing pump for continuously introducing hydrogen peroxide was installed. It was worked in such a way that the reaction container always contained 0.2% of surplus H₂O₂. For safety reasons, higher surpluses of H₂O₂ were excluded since, if spontaneous degradations occurred, they might have led to uncontrollable transformations.

In the method as per the invention, the dosing system or the hydrogen peroxide input together with the propeller stirrer, respectively, were removed. Instead, a sucking jet stirrer was installed, being made of titan in order to avoid foreign ions harming the bath in that range which is in contact with the product. The nickel powder is introduced by means of the stirrer. The stoichiometric ratio amounted to 1:1.7 (Ni:acid)—as in the other comparative tests. Water and nickel powder were each provided, sulphamic acid was put in within a temperature range of 38-40° C. in such a way that the pH value 2-3 was maintained. Directly prior to the end of the reaction, the addition of acid was dosed in such a way that a final pH value of 4.2 was achieved within a few minutes.

The reactions in adding air or hydrogen peroxide, respectively, made transformations in a low pH range necessary so that working by continuously adding acid in the pH range of e.g. 2-3 was hard to realize due to the reaction's inertance. Correspondingly, the stocks pass the pH range of up to 4.2 if the addition of acid can be performed by rates, and have substantial contents of ammonium due to hydrolysis catalyzed by acid. The very long dwell time in the higher pH range of >3.5 also greatly affects the creation of complex cationic nickel polymers.

If Mond nickel powder is used, hydrogen peroxide requires working within the substantially more acid pH range, for the most part below 1, and with a temperature of up to 60° C. Nevertheless, the transformation time is prolonged by the factor 2 in comparison to the sucking jet method. Typically, the NH₄ contents raise to 600-700 ppm. These contents and the parts of stabilizers, brought in by means of the hydrogen peroxide, degrade the sedimentations achieved from these solutions. The air-oxidation method prolongs the time necessary for transformation even further so that there is no talking about an economical production. Moreover, complex polymers are produced in the two latter methods, having a considerably disadvantageous effect on the sedimentation and only being degradable after the bath has been operated for a longer term. This is known to the person skilled in the art as so-called “training of the bath”.

The following contents of complex nickel have been determined in the production variants discussed above (cf. table 1):

| | | |
|---|---|---|
| 1. | air oxidization: | 264 mg/l nickel |
| 2. | hydrogen peroxidization: | 188 mg/l nickel |
| 3. | method as per the invention: | 5.7 mg/l nickel |

It is true that the content of undesired complex nickel can be reduced by a secondary treatment, yet this step is very time- and work-consuming.

Even a membrane filtration does not retain the complex nickel compounds discussed above. The known treatment with activated carbon does not show any better results.

The analytic results can be shown and visualized practically oriented in the form of nickel bath sedimentations. In the following, the production variants for nickel sulphamate solutions made of nickel powder and in accordance with the air-oxidation method as well as the method as per the invention are shown and compared together with the resulting sedimentation results.

Nickel was sedimentated on polished brass plates from identically formulated bathes under the same conditions.

Bath Formulation/Sedimentation Parameter:

300 g/l Ni(NH₂SO₃)₂×4H₂O

35 g/l H₃BO₃

no further additives

pH=4.0

bath temperature: 45° C.

strength of current: 1 A/dm²

sedimentation time: 30 minutes

The assessment of the nickel sedimentation was visually performed by means of measuring the level of brightness of the nickel layer. This layer has to be bright-mat and thus indicates an optimal and unperturbed nickel sedimentation. Dark to blackish sedimentations, on the other hand, show a perturbed construction of layers.

While the nickel solution as per the invention resulted in an evenly bright sedimentation, the air-oxidation method resulted in a dark to very dark test result.

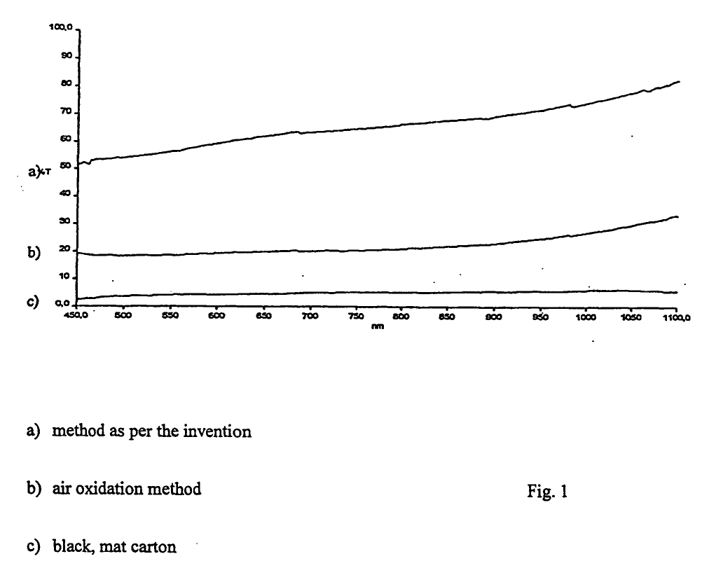

FIG. 1 shows spectra with the degree of remission of the test plates in a visible spectral region. These clearly show the differences in quality of the above-described sedimentation results.

The level of brightness was measured by means of a Perkin Elmer Lambda-2 UV-VIS spectrometer supplemented with a reflection spectroscopy device “Labsphere RSA-PE 20”. Therein, the remission of the test plates is measured by means of a hemisphere integrated therein. The percentages of the remission degrees are scaled on the ordinate of the here-enclosed spectrum.

The figures are showing:

FIG. 1a) method as per the invention

b) air-oxidization method

c) black, mat carton

The mat-black carton was measured for purposes of reference.

To sum it up, the transformation velocities of Mond nickel powder with sulphamic acid degrade considerably according to the following sequence of the methods stream stirrer (invention)—hydrogen peroxidization—air oxidization. While the stream stirrer allows for working with temperatures below 40° C. and within a pH range of 2-3, controlled by regulated input of sulphamic acid, so that the NH₄ contents are kept below 100 ppm, due to a reduction of hydrolysis caused by acid and temperature, the other two methods have to be performed under stricter conditions, and have worse results, in particular with regard to the purpose of use of electroplating bathes.

Method for Determining the Complex Nickel:

100 ml nickel sulphamate solution with 11% of nickel were thermally treated at 90° C. for 48 hours, and subsequently filtered by means of sucking via a cellulose acetate filter 0.65 μm/Sartorius number 11105-50-N, diameter 50 mm. The residue is washed by means of 50 ml superpure water, and subsequently solved in HCl of 10%. The nickel is determined in the solution by means of the common complexometric method.

By means of this determination, the content of bridged-complex nickel compounds is measured, occurring in disadvantageous amounts as an accompanying substance perturbing the nickel if the method as per the invention is not used.

1. Method for producing nickel sulphamate by means of reacting elementary nickel with sulphamic acid characterized in that the nickel is oxidized by reduction of the acid protons of the sulphamic acid and that this process is activated by means of strong stirring, mixing, or dispersing of the nickel-acid mixture by means of a stirring, mixing, or dispersing tool creating high energy density by means of creation of strong turbulences and/or introduction of high shear forces.

2. Method according to claim 1, characterized in that the stirring, mixing or dispersing performance is characterized by shear velocity of 20,000 and 100,000 l/s.

3. Method according to claim 1 or 2, characterized in that a rotating part of the stirring, mixing, or dispersing tool achieves a peripheral velocity of 10 to 40 m/s.

4. Method according to any of claims 1 to 3, characterized in that the stirring is performed by means of a stream stirrer with high frequencies, preferably by means of a sucking jet stirrer or conducting stream stirrer.

5. Method according to any of claims 1 to 4, characterized in that nickel powder is used as elementary nickel.

6. Method according to claim 5, characterized in that the nickel powder is Mond nickel powder.

7. Method according to any of claims 1 to 6, characterized in that the molar ratio of nickel to acid is over-stoichiometric, preferably 1.18:2.

8. Method according to any of claims 1 to 5, characterized in that the reaction is performed at temperatures below 40° C.

9. Method according to any of claims 1 to 8, characterized in that the elementary nickel is provided in water and that the sulphamic acid is added.

10. Method according to claim 9, characterized in that the sulphamic acid is added in portions.

11. Method according to claim 9 or 10, characterized in that the pH value of the mixture is kept between 2 and 3 for the most part of the adding, and is subsequently raised to a final value of more than 4, preferably approximately 4.2.

12. Device for performing the method according to any of claims 1 to 11, comprising a stirring tool, comprising a stream stirrer or disperser provided in a stirring container and working at high frequency, characterized by a sucking device connected with the stirrer or disperser, by means of which device nickel and/or air is sucked into the stirring container, as well as at least one dosing device for adding the sulphamic acid to the stirring container.

13. Device according to claim 12, characterized in that the stream stirrer is a sucking jet stirrer or a conducting stream stirrer.

14. Device according to claim 12, characterized in that the disperser comprises a rotor/stator system.

15. Device according to any of claims 12 to 14, characterized in that the stirrer or disperser is design for peripheral velocities of the rotating part between 10 and 40 m/s with shear speeds of up to 100,000.

16. Device according to claim 10, characterized in that those parts of the stirrer which contact the product are made of nickel, titan, hard alloy, or ceramics.
